(19) United States
(12) Patent Application Publication
(10) Pub. No.: US 2010/0288246 A1
(43) Pub. Date: Nov. 18, 2010

(54) Fuel saving heater for internal combustion engine

(75) Inventor: Naiqiang Dong, Nanjiang (CN)

Correspondence Address: Lan Way, 168 S. San Gabriel Blvd., #A, San Gabriel, CA, 91776, US

(73) Assignee: Lan Way and Rong Ying Lin

(21) Appl. No.: 12/804,532

(22) Filed: Jul. 23, 2010

Related U.S. Application Data
(63) Continuation of application No. 11/899,096, filed on Sep. 4, 2007.

(30) Foreign Application Priority Data
Aug. 23, 2000 (CN) 2392923Y

(51) Int. Cl. F02M 31/125

(52) U.S. Cl. 123/557

(57) ABSTRACT

A fuel saving heater powered by electrical energy in an automobile may be disposed at any convenient position preferably as close to an engine as possible. The device is operative without any alteration or modification to the original design of the automobile. The device has a housing means that further defines an inner chamber, inlet end, and outlet end. An infrared annular member made of heat retaining materials is in the center portion of the inner chamber. An electrical heating pipe made of heat conduction materials is wrapping around the outside surface of the annular member. Within the heating pipe, there are stuffing gauzes made of magnesium oxide and at least two sets of electrical heating elements made of heat resistance materials. The heating elements are to rapidly generate electrical heat to rapidly elevate the temperatures of three thermal exchangers of the heating pipe, the annular member, and filling metal gauzes within the inner chamber and the thermal exchangers are to rapidly elevate the temperature of the fuel via thermal conduction by means of direct contact with the fuel passing through. Multi-elements plates and a multi-metallic layer on the outside surface of the annular member are to restore the fuel back to the original stage at refinery level without bad influences of fuel additives. A nanometer-level ceramic coating on the outer surface of the heating pipe is to prevent the fuel from overheating. An electrical system has a thermocouple probe to constantly detect the temperature of the fuel with the help of an integrated circuit to rapidly activate or deactivate the heating elements. A fuel stabilizer to regulate the flow and the pressure of the fuel and to avoid excessive fuel supply waste for the engine is provided. A fuel magnetizer to magnetize the properties of the fuel and to enhance fuel vaporization for prolongation of engine life and improvement of fuel efficiency is also supplied.

### CROSS-REFERENCE TO RELATED APPLICATIONS

This continuation application claims the benefit of two prior patent applications of the Ser. No. 11/590,033 filed at Oct. 31, 2006 and the Ser. No. 11/899,096 filed at Sep. 4, 2007 by the same and sole inventor.

### BACKGROUND OF THE INVENTION

1. Field of the Invention

The invention generally relates to an internal combustion engine in an automobile, and specifically to an electrical saving device for heating, catalyzing, stabilizing, and magnetizing a fuel flowing from a fuel tank in the automobile throughout the device in order to elevate and maintain the temperature of the fuel within a preset temperature range, to improve the properties of the fuel, to prevent excessive pressure of the fuel, and to enhance fuel vaporization, and the fuel elevated and treated is then to be delivered to the engine of the automobile for efficient combustion.

2. Description of Prior Art

It is a well-known fact in automobile industry that hydrocarbon fuels such as gasoline and diesel can be more efficiently burned for an internal combustion engine in an automobile if the temperatures of the fuels are elevated and maintained within a preset optimum range than ambient temperatures at various weather conditions prior to intended combustion. To significantly improve the combustion efficiency of the fuel, many engineers in prior arts have designed numerous devices trying to elevate the temperatures of the fuels above ambient ones via three types of heat exchange media like electricity, coolant, or exhaust gas in the automobile. The media of the coolant and the exhaust gas normally require the engine running for a longer time than the electricity medium especially in cold climate to release sufficient heat for heating the fuels. Furthermore, both media may sometimes inevitably overheat the fuels to some extent so that the automobile is being exposed to a great danger of fire or explosion should fuel leakages out of a fuel pipe in the automobile occur in an accident. The electricity seems to be the most feasible and reliable medium to elevate and maintain the temperatures of the fuels for the engine if it does not cause substantial burden on a battery in the automobile.

Although many heating devices of the prior arts have proved to be operatively efficient in fuel saving for any type of engines for all automobiles, these devices definitely have attendant disadvantages in accompanying with the mere advantage of the combustion efficiency of the fuels. The disadvantages of expensive price, bulky size, difficult installation, complex design, hard replacement, and unsafe use, apparently do not thus far justify for widespread adoptions or usages by either automobile manufacturers or general public.

### OBJECTS OF THE INVENTION

It is a main object of the present invention to provide an improved fuel saving heater for an internal combustion engine in an automobile which is efficient in operation, inexpensive in price, compact in size, safe in use, easy in installation, simple in replacement, etc.

It is a further object of the present invention to provide a fuel saving heater for the engine which can be readily retrofitted on any type and model of all automobiles.

It is a further object of the present invention to provide a fuel saving heater for the engine which is capable of elevating and maintaining the temperature of a fuel to be delivered to a carburetor or a fuel injector in the automobile within a preset temperature range below the boiling point of the fuel but substantially above the ambient temperature at various weather conditions.

It is a further object of the present invention to provide a fuel saving heater which includes a built-in fuel stabilizer capable of regulating the flow and the pressure of the fuel to prevent both from reaching to an excessive or even harmful level.

It is a further object of the present invention to provide a fuel saving heater which includes a built-in fuel magnetizer capable of magnetizing the fuel and improving the properties of the fuel to prolong engine life, enhance fuel efficiency, and reduce deterioration of fuel delivery parts.

It is a further object of the present invention to provide a fuel saving heater which can be disposed at any convenient position for a fuel pipe between a fuel tank and the carburetor or the fuel injector in the automobile and can be utilized by the engine without any alteration or modification to the original design of the automobile.

The invention will be further understood and additional objects and advantages will be apparent from a consideration of the ensuing description and drawings.

### SUMMARY OF THE INVENTION

This invention relates to a fuel heating device for an internal combustion engine (not shown) in an automobile (not shown) for fuel efficiency and pollution reduction. The device comprises a housing means being made of rigid materials and defining an inner chamber, an inlet end connected with a fuel pipe (not shown) from a fuel tank (not shown) in the automobile, and an outlet end connected with the engine in the automobile to elevate the temperature of a fuel and to improve the properties of the fuel, and to establish a flow path for the fuel traveling throughout the inner chamber from the inlet end to the outlet end.

In the center portion of the inner chamber, there is an infrared annular member that has an interior passageway to rapidly elevate the temperature of the fuel passing through from the inlet end by means of direct contact via thermal conduction. The annular member, made of heat retaining materials, is elongated in shape with its big segment in small dimension at size near the inlet end and the remaining segment in large dimension at size near the outlet end. The annular member is able to maintain temperature stability within the inner chamber by gradually releasing the heat of the annular member slowly. On the outside surface of the annular member, there is sintered with a multi-metallic layer. The layer is capable of performing a catalysis process to improve the properties of the fuel for efficient combustion by restoring the fuel back to the original stage at refinery level before delivery to gas stations without bad influences of adding fuel additives.

Wrapping and winding around the outside surface of the big segment in small dimension at size of the annular member near the inlet end, there is a spiral, electrical heating pipe made of heat conduction materials. The reason for the spiral heating pipe wrapping around the outside surface of the annular member is to rapidly elevate the temperature of the annular member and the temperature of the interior passageway by means of direct and indirect contact via thermal conduction. The major purposes for the spiral heating pipe to wrap around the outside surface of the annular member near the inlet end are to spread large contact regions for the annular member and to promote heat conduction from the heating pipe to the annular member. The minor purpose to wrap around the annular member is to hold the annular member in a firm and stable position within the inner chamber. The heating pipe safely enters into the housing means from (an entering)/one position near the inlet end and safely exits out the housing means from (an exiting)/another position near the outlet end. Both the positions of the heating pipe are fixed and sealed safely with the housing means by threaded engagements (not shown) to prevent unnecessary fuel leakages.

There are at least two or a plurality of sets of electrical heating elements made of heat resistance materials and attached firmly on the inner wall of the heating pipe. The heating elements regulated by semiconductor controllers are adjoined and touched together all the time. All sets of the heating elements are encircling and winding extensively within the internal room of the heating pipe to spread large contact regions for the heating pipe and to rapidly generate and conduct electrical heat. The objective to dispose all sets of the heating elements within the heating pipe is to avoid direct contact with the fuel for safety concerns. The reason for the heating pipe made of heat conduction materials is to rapidly conduct the electrical heat from the heating pipe to the annular member and to filling metal gauzes. The reason for the annular member made of heat retaining materials is to gradually release the electrical heat from the annular member to the heating pipe and the filling metal gauzes. The heating elements are to rapidly generate and conduct the electrical heat for rapidly elevating the temperature of the heating pipe by means of direct contact with the heating pipe via thermal conduction.

Besides the internal room of the heating pipe occupied by the heating elements, other internal room is occupied with stuffing gauzes (not shown) made of magnesium oxide with heat conduction and electricity insulation in nature. The stuffing gauzes can electrically insulate all sets of the heating elements and hold all sets of the heating elements in their firm, stable, and respective positions. The stuffing gauzes can evenly conduct the electrical heat from the heating elements to the heating pipe by means of direct contact via thermal conduction. The heating elements and the stuffing gauzes both within the heating pipe can rapidly and evenly generate and conduct the electrical heat from the heating elements to the heating pipe and can rapidly and evenly elevate the temperature of the heating pipe via thermal conduction by means of direct contact with the heating pipe.

Besides the internal room of the inner chamber occupied by the annular member and the heating pipe, other internal room of the inner chamber is occupied with the filling metal gauzes and multi-elements plates. The multi-elements plates may be disposed near the inlet end or the outlet end within the inner chamber. The multi-elements plates made of catalysis materials are also capable of performing the catalysis process to improve the properties of the fuel for efficient combustion by restoring the fuel back to the original stage at refinery level before delivery to gas stations without bad influences of adding fuel additives. The heat of the heating pipe is to rapidly elevate the temperature of the annular member, the temperature of the interior passageway, and the temperature of the filling metal gauzes via thermal conduction by means of direct and indirect contact with the heating pipe. The heat of the annular member is to rapidly elevate the temperature of the interior passageway and the temperature of the filling metal gauzes via thermal conduction by direct and indirect contact with the annular member. The heat of the heating pipe and the annular member is to rapidly elevate the temperature of the filling metal gauzes via thermal conduction by means of direct and indirect contact with the heating pipe and the annular member.

The filling metal gauzes can hold the annular member in a firm and stable position within the inner chamber. The filling metal gauzes can absorb the heat diffused from the heating pipe and the annular member for elevating the temperature of the fuel via thermal conduction by means of direct contract with the fuel passing through. Three thermal exchangers of the heating pipe, the annular member including the interior passageway, and the filling metal gauzes are to rapidly elevate the temperature of the fuel via thermal conduction by means of direct contract with the fuel passing throughout the inner chamber from the inlet end to the outlet end.

On the outer surface of the heating pipe, there is sprayed with a nanometer-level ceramic coating to lessen the extent of thermal conduction between the heating pipe and the fuel passing through for safety concerns and to prevent the fuel passing through in direct contact with the outer surface of the heating pipe from overheating. The heating pipe and the annular member and/including the interior passageway and the filling metal gauzes fully exploit the electrical heat generated by the heating elements to rapidly elevate the temperature of the fuel via thermal conduction by means of direct contact with the fuel passing through to establish the flow path of the fuel to be elevated in the temperature and to be treated in the properties.

The three thermal exchangers are to rapidly elevate and maintain the temperature of the fuel passing through to maximum extent via thermal conduction by means of direct contact with the heating pipe and the outside surface of the annular member. The three thermal exchangers are to rapidly elevate and maintain the temperature of the fuel passing through to medium extent via thermal conduction by means of direct contact with the interior passageway of the annular member. The three thermal exchangers are to merely elevate and maintain the temperature of the fuel passing through to minimum extent via thermal conduction by means of direct contact solely with the filling metal gauzes. The fuel heating device for the engine in the automobile is to rapidly conduct, elevate, and maintain the temperature of the fuel traveling throughout the inner chamber from the inlet end to the outlet end to various temperatures/extents via thermal conduction by means of direct contact with the three thermal exchangers of the electrical heating pipe and the infrared annular member and the filling metal gauzes and/including the interior passageway of the annular member all within the inner chamber of the housing means.

The three thermal exchangers are to promote thermal conduction one another within the inner chamber and to rapidly elevate the temperature of the fuel via thermal conduction by means of direct contact with the fuel passing through the device. The fuel heating device fully exploits the electrical heat generated by the electrical heating elements to rapidly and evenly conduct, elevate, and maintain the temperature of the fuel traveling throughout the inner chamber from the inlet end to the outlet end via thermal conduction by means of direct contact with the three thermal exchangers. The three thermal exchangers of the heating pipe and the annular member and the filling metal gauzes along with the electrical heating elements and the stuffing gauzes, are to rapidly and evenly generate and conduct the electrical heat and to rapidly elevate and maintain the temperature of the fuel traveling throughout the inner chamber from the inlet end to the outlet end to various the temperatures/extents by means of direct contact via thermal conduction.

Throughout rapidly generating the electrical heat by the heating elements, evenly conducting the generating heat by the stuffing gauzes, rapidly conducting the generating heat by the three thermal exchangers, and gradually releasing the retaining heat by the annular member, the device is capable of having maintained the temperature stability within the inner chamber. Even after an ignition switch (not shown) in the automobile is turned off, the annular member can still maintain the temperature stability within the inner chamber because of its heat retaining nature for a long period of time.

The fuel heating device has a thermocouple probe at an advantageous junction of the outlet end to constantly detect an ever-changing specific temperature of a steady fuel by means of direct contact with the steady fuel at a mixing moment. The probe is connected with two electronic instruments of the semiconductor controllers and an integrated circuit both on an electrical circuit board further connected with a battery (not shown) in the automobile. Three instruments of the probe, the integrated circuit, and the controllers are important components of an electrical system for the device. The device under the instruction of the integrated circuit with help of the probe instructs the controllers to actuate, activate, and deactivate the heating elements and to lessen, elevate, and maintain the temperature of the fuel passing through.

A fuel stabilizer, disposed and attached on the inner wall of the inlet end, able to regulate the flow and the pressure of the fuel passing from the fuel tank in the automobile to a constantly balancing level upon initial entrance into the device is supplied. The stabilizer is to avoid any unnecessary, excessive fuel supply waste in combustion chambers (not shown) in the engine. A or an alternative fuel magnetizer, disposed and attached on the inner wall of the outlet end, able to magnetize the properties of the fuel passing from the inner chamber and to enhance fuel vaporization for prolongation of engine life, improvement of fuel efficiency, and deterioration reduction of fuel delivery parts is also supplied.

All fuel at the advantageous junction of the outlet end with various the temperatures/extents from different directions converge and blend together to develop into the steady fuel with the specific temperature at the mixing moment because of the design of the magnetizer to greatly reduce cold and hot spots in the fuel for the device. The thermocouple probe at the advantageous junction of the outlet end is constantly detecting the specific temperature of the steady fuel by means of direct contact with the steady fuel at the mixing moment. The probe at the advantageous junction of the outlet end is constantly converting the specific temperature of the steady fuel into an electronic signal to be sent to the integrated circuit. The probe at the advantageous junction of the outlet end is continually repeating the detecting function and the monitoring function as long as the engine of the automobile is turned on.

The probe at the advantageous junction of the outlet end with the help of the integrated circuit on the circuit board is constantly monitoring the specific temperature of the steady fuel to determine whether the specific temperature of the steady fuel is within a preset temperature range or not. Should the specific temperature of the steady fuel is above or below the preset temperature range, the controllers on the circuit board are to rapidly actuate, deactivate, or activate (all sets except one set)/other sets of the electrical heating elements. The controllers on the circuit board are rapidly activating and deactivating the other sets of the heating elements and are continually repeating the activating function and the deactivating function as long as the engine of the automobile is turned on. This very one set of the heating elements has been continually working to prevent the temperature of the fuel dropping below the preset temperature range unless the engine of the automobile is turned off.

The probe at the advantageous junction of the outlet end is constantly/continually detecting and monitoring the temperature of the fuel and the controllers on the circuit board are rapidly/continually activating and deactivating the heating elements to lessen, elevate, and maintain the temperature of the fuel as long as the engine of the automobile is turned on. The probe at the advantageous junction of the outlet end is constantly/continually detecting and monitoring the temperature of the fuel and the controllers and the integrated circuit on the circuit board are rapidly/continually activating and deactivating the heating elements to lessen, elevate, and maintain the temperature of the fuel as long as the engine of the automobile is turned on. Because of the design of the magnetizer, the device is able to greatly reduce the cold and hot spots in the fuel.

By strategically selecting the advantageous junction of the outlet end for the thermocouple probe to constantly detect the specific temperature of the steady fuel passing through the magnetizer before final exit of the device, any wise person may agree that the detected temperature should rightfully represent a true temperature in the fuel for the device. According to this reasoning, the device intelligently adopts the detected temperature of the fuel at the advantageous junction of the outlet end as the true temperature in the fuel—a yardstick for the controllers under the instruction of the integrated circuit with the help of the probe to rapidly actuate, deactivate, or activate each set of the heating elements respectively.

Both the electrical circuit board and the housing means made of rigid materials are mounted over a holding base on the automobile. The fuel heating device is suitable for all types of fuels: regular gasoline, premium gasoline, ethanol gasoline, methanol gasoline, diesel fuel, emulsified fuel, and composite fuel. Each type of the fuels has its own preset temperature range for efficient combustion of the engine.

### BRIEF DESCRIPTION OF THE DRAWINGS

Additional objectives, features, and advantages of the present invention will be apparent from the following detailed description and appended claims in conjunction with accompanying drawings, and like reference numerals designate like parts and elements throughout all figures in the drawings, wherein

FIG. 1 is a sectional view of a fuel saving heater showing all principal parts in accordance with the present invention.

FIG. 2 is a sectional view of a fuel stabilizer showing all principal parts in accordance with the present invention.

FIG. 3 is an outline of an electrical system in accordance with the present invention.

FIG. 4 are sectional and perspective views of two different embodiments for a fuel magnetizer and its two principal parts—an inner cylindrical magnetic member and an outer cylindrical magnetic member—in accordance with the present invention.

FIG. 5 are three exploded views of one principal part—a tubular sleeve—for the preferred embodiment of the fuel magnetizer.

FIG. 6 are three exploded views of three principal parts—the inner cylindrical magnetic member, the outer cylindrical magnetic member, and a spacer ring—for the preferred embodiment of the fuel magnetizer.

FIG. 7 are orthogonal views of the fuel magnetizer in accordance with the present invention.

FIG. 8 are orthogonal views for the alternative embodiment of the fuel magnetizer.

### DETAILED DESCRIPTION OF THE PREFERRED EMBODIMENT

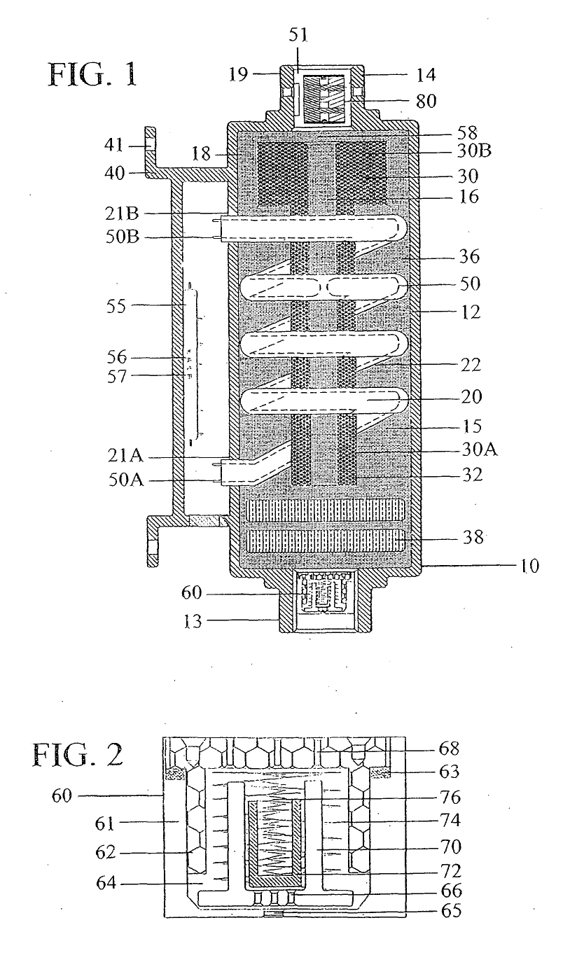

With particular reference to FIG. 1, a fuel heating device 10 is to elevate the temperature of a fuel and to improve the properties of the fuel for an internal combustion engine (not shown) in an automobile (not shown) in accordance with the preferred embodiment of this present invention for fuel efficiency and pollution reduction. The device 10 comprises an elongated housing means 12 made of rigid materials, an inlet end 13 connected with a fuel pipe (not shown) from a fuel tank (not shown) in the automobile, an outlet end 14 connected with the engine in the automobile, and a holding base 40. The device 10 may be installed on any convenient position in the automobile preferably as close to the engine of the automobile as possible. The housing means 12 defines an elongated inner chamber 15 in the middle along with the inlet end 13 at one side and the outlet end 14 at other side to establish a flow path for the fuel traveling throughout the inner chamber 15 from the inlet end 13 to the outlet end 14.

There is an infrared annular member 30 in the center portion of the inner chamber 15 between the inlet end 13 and the outlet end 14. The elongated annular member 30 can be divided into two different segments. The big segment is in small dimension at size 30A with its one side near the inlet end 13. The small segment is in large dimension at size 30B with its other side near the outlet end 14. The annular member 30, made of heat retaining materials, further has an interior passageway 16 to rapidly elevate the temperature of the fuel passing through from the inlet end 13. The housing means 12 mounted over the round base 40 is fixed securely by a plurality of installation holes 41 by means of fastening means (not shown) like screws or bolts. The fuel heating device 10 has a thermocouple probe 51 at the outlet end 14 and two electronic instruments of semiconductor controllers 56 and an integrated circuit 57 both on an electrical circuit board 55 connected with a battery (not shown) over the holding base 40 on the automobile.

Wrapping and winding around the outside surface of the big segment in small dimension at size 30A of the annular member 30 near the inlet end 13, there is a spiral, electrical heating pipe 20. The heating pipe 20, made of heat conduction materials, safely enters into the housing means 12 from (an entering)/one position 21A near the inlet end 13 and safely exits out the housing means 12 from (an exiting)/another position 21B near the outlet end 14. Both the positions 21A and 21B of the heating pipe 20 are fixed and sealed safely with the housing means 12 by threaded engagements (not shown) to prevent unnecessary fuel leakages. The major purposes for the spiral heating pipe 20 to wrap around the outside surface of the annular member 30 near the inlet end 13 are to spread large contact regions for the annular member 30 and to promote heat conduction from the heating pipe 20 to the annular member 30. The minor purpose to wrap around the annular member 30 is to hold the annular member 30 in a firm and stable position within the inner chamber 15.

There are at least two or a plurality of sets of electrical heating elements 50, made of (positive temperature coefficient of) heat resistance materials and regulated by the semiconductor controllers 56. All sets of the heating elements 50 are adjoined and touched together all the time and attached firmly on the inner wall of the heating pipe 20. For safety concerns, all sets of the heating elements 50 are disposed within the heating pipe 20 to avoid any direct contact with the fuel passing through. All sets of the heating elements 50 are encircling and winding extensively within the internal room of the heating pipe 20 to spread large contact regions for the heating pipe 20 and to rapidly generate and conduct electrical heat. The reason for the heating pipe 20 made of heat conduction materials is to rapidly conduct the electrical heat from the heating pipe 20 to the annular member 30 and to the filling metal gauzes 36. Both the heating elements 50 and the controllers 56 are connected with the battery and actuated by an ignition switch (not shown) in the automobile to deliver electrical current to the heating elements 50.

The heating elements 50 are to rapidly generate and conduct the electrical heat and to rapidly elevate the temperature of the heating pipe 20 by means of direct contact with the heating pipe 20 via thermal conduction. The heat of the heating pipe 20 is to rapidly elevate the temperature of the annular member 30 and the temperature of the interior passageway 16 by means of direct and indirect contact via thermal conduction. The heat of the heating pipe 20 and the annular member 30 is to rapidly elevate the temperature of the filling metal gauzes 36 by means of direct and indirect contact via thermal conduction. The heating pipe 20 and the annular member 30 and/including the interior passageway 16 and the filling metal gauzes 36 fully exploit the electrical heat generated by the heating elements 50 to rapidly elevate the temperature of the fuel via thermal conduction by means of direct contact with the fuel traveling throughout the inner chamber 15 from the inlet end 13 to the outlet end 14 to establish the flow path for the fuel to be elevated in the temperature and to be treated in the properties.

Besides the internal room of the heating pipe 20 occupied by the heating elements 50, other internal room of the heating pipe 20 is occupied with stuffing gauzes (not shown) made of magnesium oxide with heat conduction and electricity insulation in nature. The stuffing gauzes can insulate electrically all sets of the heating elements 50 and hold all sets of the heating elements 50 in their firm, stable, and respective positions. The stuffing gauzes also serve another functioning to evenly conduct the electrical heat from the heating elements 50 to the heating pipe 20 by means of direct contact via thermal conduction. The heating elements 50 and the stuffing gauzes both within the heating pipe 20 can rapidly and evenly generate and conduct the electrical heat from the heating elements 50 to the heating pipe 20 and can rapidly and evenly elevate the temperature of the heating pipe 20 via thermal conduction by means of direct contact with the heating pipe 20. On the outer surface of the heating pipe 20, there is sprayed with a nanometer-level ceramic coating 22 to prevent the fuel passing through in direct contact with the outer surface of the heating pipe 20 from overheating. The ceramic coating 22 practically works to lessen the extent of thermal conduction between the heating pipe 20 and the fuel passing through for safety concerns. Likewise to the stuffing gauzes filled within the heating pipe 20 besides the heating elements 50, there are multi-elements plates 38 and the filling metal gauzes 36 occupied within the internal room of the inner chamber 15 besides the annular member 30 and the heating pipe 20.

The heating elements 50 rapidly generate and conduct the electrical heat to rapidly elevate the temperature of the heating pipe 20 by means of direct contact, the temperature of the annular member 30 by means of direct contact, the temperature of the interior passageway 16 by means of direct contact, and the temperature of the filling metal gauzes 36 by direct and indirect contact via thermal conduction. The spiral heating pipe 20 wrapping around the outside surface of the annular member 30 is to rapidly elevate the temperature of the annular member 30 and the temperature of the interior passageway 16 by means of direct and indirect contact via thermal conduction. The heating pipe 20 and the annular member 30 are to rapidly elevate the temperature of the filling metal gauzes 36 via thermal conduction by direct and indirect contact with the heating pipe 20 and the annular member 30. The heating pipe 20, the annular member 30, and the filling metal gauzes 36 are to rapidly elevate the temperature of the fuel via thermal conduction by means of direct contact with the fuel traveling throughout the inner chamber 15 from the inlet end 13 to the outlet end 14.

Three thermal exchangers of the heating pipe 20, the annular member 30 and/including the interior passageway 16, and the filling metal gauzes 36 are to fully exploit the electrical heat generated by the heating elements 50, to promote thermal conduction one another within the inner chamber 15, and to rapidly elevate the temperature of the fuel passing through via thermal conduction by means of direct contact with the three thermal exchangers. The temperature of the heating pipe 20 is rapidly elevated via thermal conduction by means of direct contact with the heating elements 50. The temperature of the annular member 30 is rapidly elevated via thermal conduction by means of direct contact with the heating pipe 20. The temperature of the filling metal gauzes 36 is rapidly elevated via thermal conduction by means of direct and indirect contact with the heating pipe 20 and the annular member 30.

The filling metal gauzes 36 can absorb the heat diffused from the heating pipe 20 and the annular member 30 for elevating the temperature of the fuel via thermal conduction by means of direct contract with the fuel passing through. The filling metal gauzes 36 can hold the annular member 30 in a firm and stable position within the inner chamber 15. The heating elements 50 and the stuffing gauzes rapidly and evenly generate and conduct the electrical heat by means of direct and indirect contact via thermal conduction to rapidly elevate the temperatures of the three thermal exchangers. The device 10 is to rapidly conduct, elevate, and maintain the temperature of the fuel traveling throughout the inner chamber 15 from the inlet end 13 to the outlet end 14 to various temperatures/extents via thermal conduction by means of direct contact with the three thermal exchangers and the interior passageway 16 of the annular member 30.

In terms of the three thermal exchangers and the heat conduction order of the electrical heat generated by the heating elements 50, the heating pipe 20 is the first, the annular member 30 and few of the filling metal gauzes 36 touching the heating pipe 20 are the second, and the rest of the filling metal gauzes 36 are the last. In terms of the three thermal exchangers and the heat reception extent of the electrical heat generated by the heating elements 50, the heating pipe 20 and the outside surface of the annular member 30 receive maximum extent of the heat conduction, the interior passageway 16 of the annular member 30 receives medium extent of the heat conduction, and all of the filling metal gauzes 36 receive minimum extent of the heat conduction. The three thermal exchangers are to rapidly elevate and maintain the temperature of the fuel passing through to the maximum extent via thermal conduction by means of direct contact with the heating pipe 20 and the outside surface of the annular member 30. The three thermal exchangers are to rapidly elevate and maintain the temperature of the fuel passing through to the medium extent via thermal conduction by means of direct contact with the interior passageway 16 of the annular member 30. The three thermal exchangers are to merely elevate and maintain the temperature of the fuel passing through to the minimum extent via thermal conduction by means of direct contact solely with the filling metal gauzes 36.

The fuel heating device 10 for the engine in the automobile is to rapidly conduct, elevate, and maintain the temperature of the fuel traveling throughout the inner chamber 15 from the inlet end 13 to the outlet end 14 to various the temperatures/extents via thermal conduction by means of direct contact with the three thermal exchangers of the electrical heating pipe 20 and the infrared annular member 30 and the filling metal gauze 36 and/including the interior passageway 16 of the annular member 30 all within the inner chamber 15 of the housing means 12.

The device 10 fully exploits the electrical heat generated by the electrical heating elements 50 to rapidly and evenly conduct, elevate, and maintain the temperature of the fuel traveling throughout the inner chamber 15 from the inlet end 13 to the outlet end 14 via thermal conduction by means of direct contact with the three thermal exchangers. The three thermal exchangers of the heating pipe 20 and the annular member 30 and the filling metal gauzes 36 along with the electrical heating elements 50 and the stuffing gauzes are to rapidly and evenly generate and conduct the electrical heat and to rapidly elevate and maintain the temperature of the fuel traveling throughout the inner chamber 15 from the inlet end 13 to the outlet end 14 to various the temperatures/extents by means of direct contact via thermal conduction.

The annular member 30 made of heat retaining materials can maintain temperature stability within the inner chamber 15 by gradually releasing the retaining heat of the annular member 30 slowly. Throughout rapidly generating the electrical heat by the heating elements 50, evenly conducting the generating heat by the stuffing gauzes, rapidly conducting the generating heat by the three thermal exchangers, and gradually releasing the retaining heat by the annular member 30, the device 10 is capable of having maintained the temperature stability within the inner chamber 15. Even after the ignition switch of the automobile is turned off, the annular member 30 can still maintain the temperature stability within the inner chamber 15 for a long period of time because of the heat retaining nature of the annular member 30.

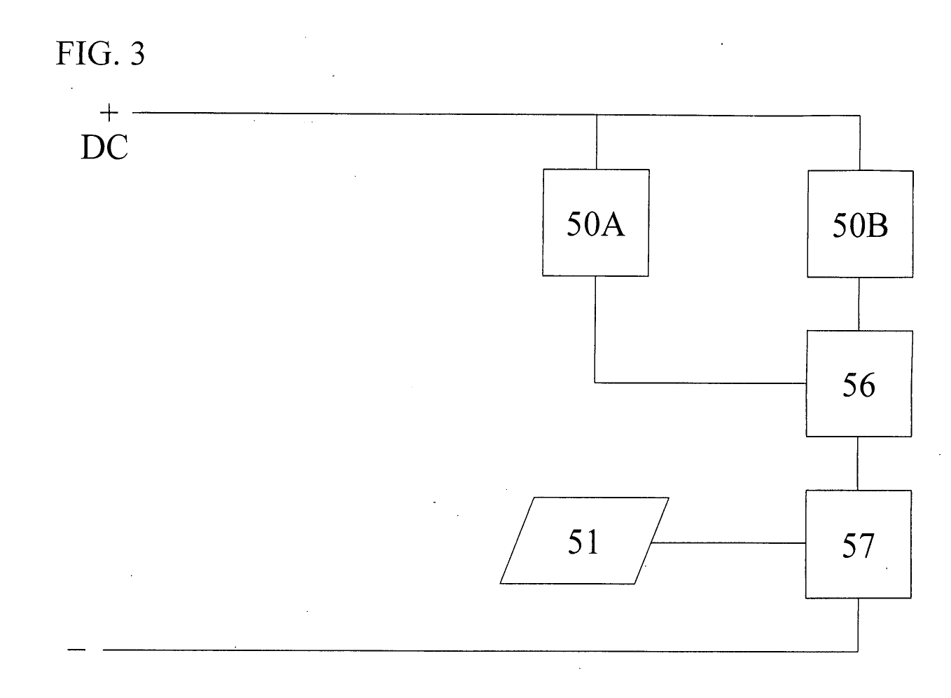

With particular reference to FIGS. 1 and 3, when the ignition switch of the automobile is turned on, the thermocouple probe 51 with two conductor wires enclosed within a sheath (not shown) at an advantageous junction 19 of the outlet end 14 starts to constantly detect an ever-changing specific temperature for the fuel. There are three reasons to explain why the temperature of the fuel is ever-changing: the extent of the heat generated from the heating elements 50, the extent of the heat absorbed by the fuel from the three thermal exchangers of the heating pipe 20 and the annular member 30 and/including the interior passageway 16 and the filling metal gauzes 36, and flow paths of the fuel within the inner chamber 15. There are two flow paths as the fuel enters into the device 10, travels through the inner chamber 15, and exits out the device 10. For both paths, the fuel enters into the device 10 from the inlet end 13 and exits out the device 10 from the outlet end 14. The difference between the two flow paths is the way of how the fuel travels through the inner chamber 15. For one path, the fuel travels through the inner chamber 15 via the interior passageway 16 of the annular member 30. For another path, the fuel travels through the inner chamber 15 via annular hollow 18 between the annular member 30 and the inner wall of the housing means 12. The latter fuel, which can be moreover subdivided into the fuel with different directions due to the shape of the annular member 30, may carry various temperatures because of different extents of heat absorption from thermal conduction. At the area 58 between the annular member 30 and the outlet end 14, all fuel with various the temperatures/extents from the different directions converge and blend together to develop into a steady fuel with the ever-changing specific temperature at a mixing moment because of the shape of the annular member 30 to greatly reduce cold and hot spots in the fuel for the device 10.

The fuel heating device 10 has the thermocouple probe 51 connected with the semiconductor controllers 56 and the integrated circuit 57 both on the electrical circuit board 55, and all further connected with the battery in the automobile before the fuel finally exits out the device 10. The thermocouple probe 51 is often detecting a lower temperature of the fuel at ambient surroundings especially in cold weather than a temperature range preset by optimum combustion for any type of fuels. The device 10 under the instruction of the integrated circuit 57 with the help of the probe 51 instructs the controllers 56 to rapidly actuate all sets of the heating elements to elevate the temperatures of the three thermal exchangers and the temperature of the fuel passing through. As soon as the probe 51 is detecting the temperature of the fuel reaching one degree Fahrenheit above the preset temperature range, the integrated circuit 57 instructs the controllers 56 to deactivate the other sets of the heating elements 50 for preventing the fuel from overheating. This only one set of the heating elements 50A not deactivated by the controllers 56 has been continually working to maintain the temperature of the fuel within the preset temperature range as long as the engine of the automobile is turned on. As soon as the probe 51 is detecting the temperature of the fuel dropping one degree Fahrenheit below the preset temperature range, the integrated circuit 57 instructs the controllers 56 to activate the heating elements 50B for elevating the temperature of the fuel again. The probe 51, the integrated circuit 57, and the controllers 56 all work together to rapidly/continually actuate, deactivate, or activate the heating elements 50 in order to comply with the preset temperature range in accordance with a true temperature for the steady fuel detected by the probe 51.

On the outside surface of the annular member 30, there is sintered with a multi-metallic layer 32. The layer 32 is capable of performing a catalysis process to improve the properties of the fuel for efficient combustion by restoring the fuel back to the original stage at refinery level before delivery to gas stations without bad influences of adding fuel additives. The reason for the catalysis process to improve the combustion efficiency of the fuel is that all refineries usually add additives to the fuel before delivery to gas stations for numerous reasons like safety, logistics, or antifreeze. Unfortunately, these additives are not helpful or even harmful for the fuel to be burned efficiently in the engine. To further improve the properties of the fuel upon its initial entry into and final exit out the device 10, a plurality of the multi-elements plates 38, made of catalysis materials which are used often by refineries, may be disposed within the inner chamber 15 near the inlet end 13 or the outlet end 14. The multi-elements plates 38 are capable of performing the catalysis process to improve the properties of the fuel for efficient combustion by restoring the fuel back to the original stage at refinery level before delivery to gas stations without bad influences of adding fuel additives.

With particular reference to FIG. 2, a fuel stabilizer 60 disposed and attached on the inner wall of the inlet end 13 to regulate the flow and the pressure of the fuel passing from the fuel tank in the automobile to a constantly balancing level upon initial entrance into the device 10. The stabilizer 60 is to avoid any unnecessary, excessive fuel supply waste in combustion chambers (not shown) in the engine. The stabilizer 60 comprises a cup-shaped inlet casing means 61 and a cup-shaped outlet casing means 62. Both are made of stiff materials and are disposed and attached on the inner wall of the inlet end 13 for the device 10. The cup-shaped inlet and outlet casing means 61 and 62 are clamped 63 together to form an enclosure 64. The inlet casing means 61 further has an inlet orifice 65 in the center portion of the inlet casing means 61 normally to permit the fuel passing from the fuel tank to enter into the stabilizer 60. The outlet casing means 62 further has a plurality of outlet apertures 68 in the center portion of the outlet casing means 62 always to permit the fuel passing from the enclosure 64 to enter into the inner chamber 15 of the device 10.

In the enclosure 64, there is a u-shaped large piston 70. The bottom part of the large piston 70 is close and parallel to the inner wall of the inlet casing means 61. The large piston 70 has a plurality of inlet apertures 66 in the center portion of the large piston 70 normally to permit the fuel passing from the inlet orifice 65 to enter into the enclosure 64. Sometimes the large piston 70 may deny some flow passage of the fuel passing from the inlet orifice 65 to enter into the enclosure 64 when the large piston 70 is to perform a moving function toward the inlet casing means 61 to block some flow passage of the fuel passing from the inlet orifice 65 to enter into the enclosure 64. There is a large compression spring 74 disposed and extended between the large piston 70 and the outlet casing means 62. One side of the compression spring 74 is attached to the inner wall of the large piston 70, whereas the other side of the compression spring 74 is attached to the inner wall of the outlet casing means 62. The compression spring 74 is to provide a restraining force to push the large piston 70 toward the inlet casing means 61.

There is also a u-shaped small piston 72 disposed in the pocket of the large piston 70 in the enclosure 64. The bottom part of the small piston 72 is close and parallel to the bottom part of the large piston 70. The small piston 72 is normally to permit the fuel passing from the inlet apertures 66 to enter into the enclosure 64. Sometimes the small piston 72 may deny some flow passage of the fuel passing from the inlet apertures 66 to enter into the enclosure 64 when the small piston 72 is to perform a moving function toward the large piston 70 to block some flow passage of the fuel passing from the inlet apertures 66 to enter into the enclosure 64. There is a small tension spring 76 disposed and extended between the small piston 72 and the outlet casing means 62. One side of the tension spring 74 is attached to the inner wall of the small piston 72, whereas the other side of the tension spring 74 is attached to the inner wall of the outlet casing means 62. The tension spring 76 is to provide a restraining force to push the small piston 72 toward the large piston 70. The stabilizer 60 is fully utilizing the restraining force of the compression spring 74 and the restraining force of the tension spring 76 in accompanying with the moving function of the large piston 70 and the moving function of the small piston 72 to block some flow passage of the fuel in order to achieve a constantly balancing level for the flow and the pressure of the fuel passing through to avoid the unnecessary, excessive fuel supply waste in the combustion chambers in the engine.

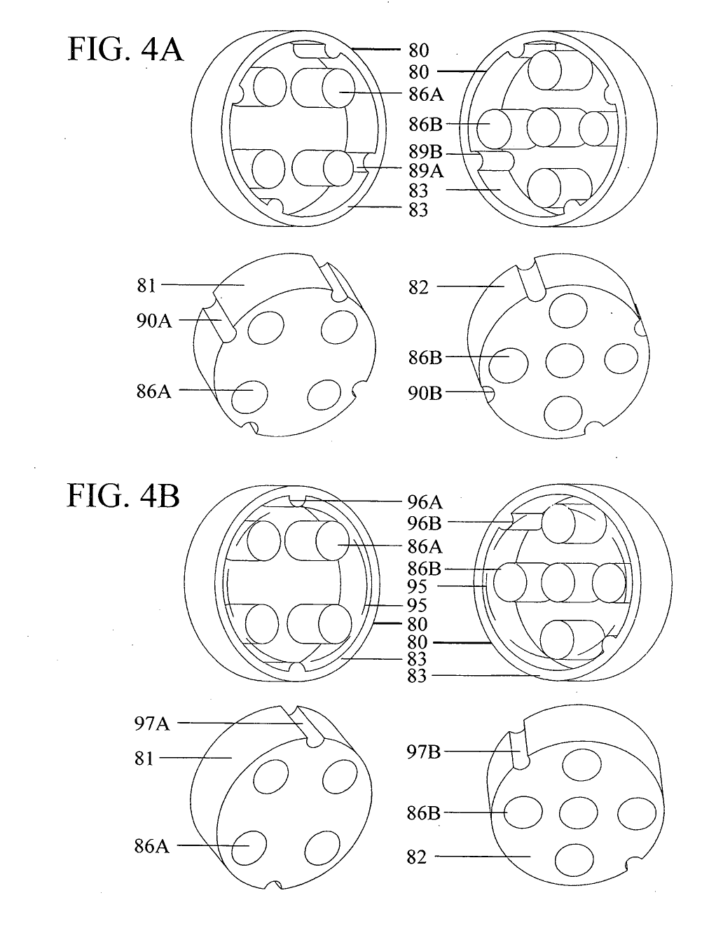

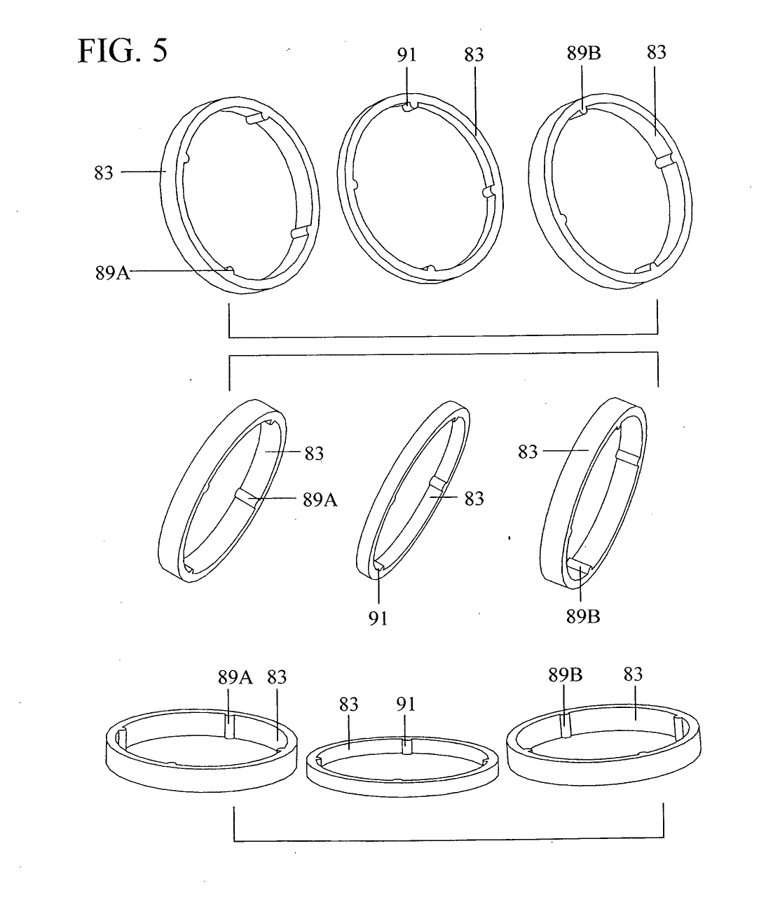

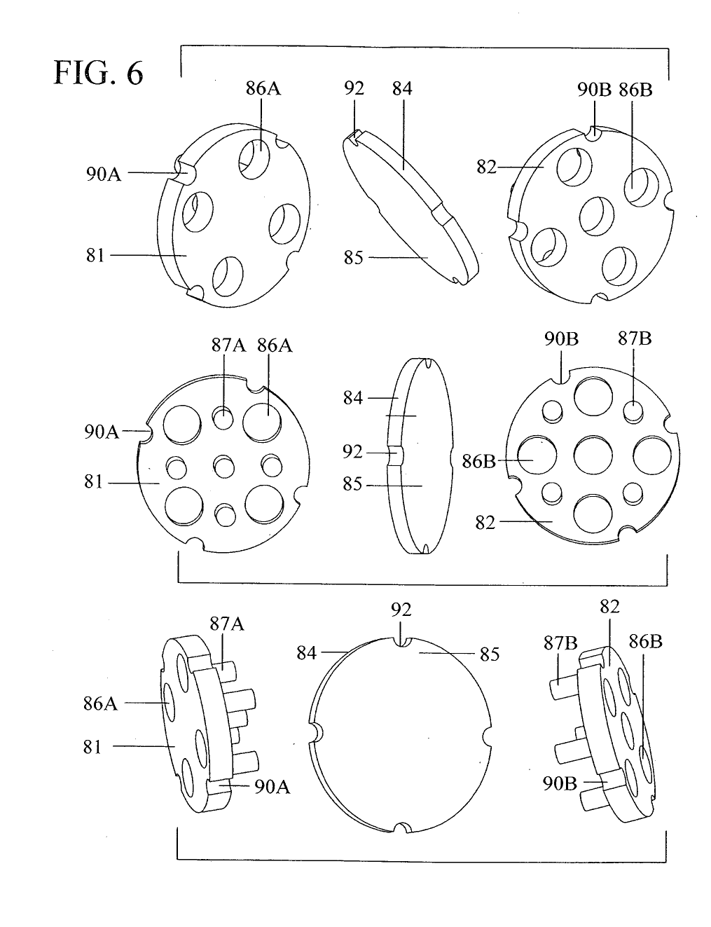

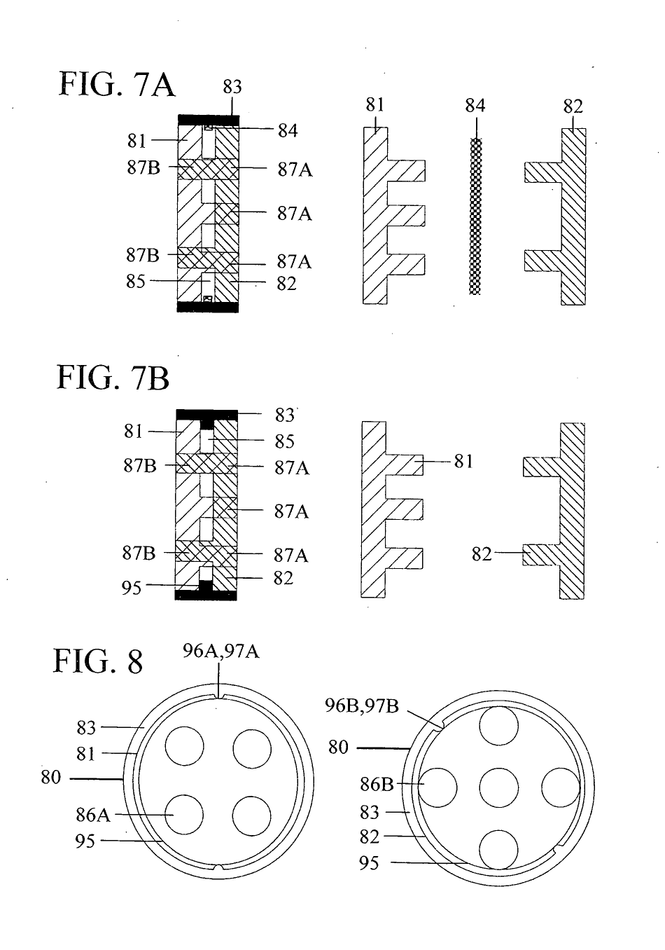

With particular reference to FIGS. 4A, 5, 6, 7A, and 8, a fuel magnetizer 80 is to magnetize the properties of the fuel passing from the inner chamber 15 and to enhance fuel vaporization for prolongation of engine life, improvement of fuel efficiency, and deterioration reduction of fuel delivery parts. The magnetizer 80 is disposed and attached on the inner wall of the outlet end 14 of the device 10. The magnetizer 80 comprises an outer cylindrical magnetic member 81, an inner cylindrical magnetic member 82, a tubular sleeve 83, and a spacer ring 84. With regard to the disposition, the inner magnetic member 82 is closer to the annular member 30 than the outer magnetic member 81. Both the outer magnetic members 81 and the inner magnetic members 82 are made of Nd—Fe—B permanent magnet, whereas the tubular sleeve 83 and the spacer ring 84 are fuel resistance materials.

The outer magnetic member 81 has four keyways 90A around the external cylindrical surface of the outer magnetic member 81 to be inserted into by four respective splines 89A of the tubular sleeve 83 correspondingly. The inner magnetic member 82 has four keyways 90B around the external cylindrical surface of the inner magnetic member 82 to be inserted into by four respective splines 89B of the tubular sleeve 83 correspondingly. The outer magnetic member 81 has four round passage holes 86A to allow the fuel to exit out the magnetizer 80 and five cylinder projections 87A to extend into the corresponding round passage holes 86B of the inner magnetic member 82 to create magnetic fields within the passage holes 86B. The inner magnetic member 82 has five round passage holes 86B to allow the fuel to enter into the magnetizer 80 and four cylinder projections 87B to extend into the corresponding round passage holes 86A of the outer magnetic member 81 to create magnetic fields within the passage holes 86A. The identical diameter of each round passage hole 86 in terms of length is exactly twice long as the identical diameter of each cylinder projection 87 for both the outer magnetic member 81 and the inner magnetic member 82.

The tubular sleeve 83 has four respective splines 91 over the center portion of the internal surface of the tubular sleeve 83 to insert into four keyways 92 of the spacer ring 84. The tubular sleeve 83 has four respective splines 89A over one side of the internal surface of the tubular sleeve 83 to insert into the keyways of the outer magnetic member 81 correspondingly. The tubular sleeve 83 has four respective splines 89B over other side of the internal surface of the tubular sleeve 83 to insert into the keyways of the inner magnetic member 82 correspondingly.

The spacer ring 84 disposed in the center portion of the magnetizer 80 has four keyways 92 around the external ring surface of the spacer ring 84 to allow respective the splines over the center portion of the internal surface of the tubular sleeve 83 to be inserted into. The spacer ring 84 is to separate the outer magnetic member 81 from the inner magnetic member 82 for defining a cavity 85 with a magnetic field within the cavity 85 because of Nd—Fe—B permanent magnet. The cavity 85 between the outer magnetic member 81 and the inner magnetic member 82 is to provide excessive fuel flowing from the inner magnetic member 82 to be accumulated and to be treated there by a magnetic field generated by said Nd—Fe—B permanent magnet prior to entrance into the outer magnetic member 81.

The magnetizer 80 utilizes the splines 89 and 91 and the keyways 90 and 92 to hold the tubular sleeve 83, the spacer ring 84, the outer magnetic members 81, and the inner magnetic members 82 as a cohesive unit. The magnetic fields within the passage holes 86B of the outer magnetic member 81, the cavity 85, and the passage holes 86A of the inner magnetic member 82 develop a magnetic flow path for the fuel throughout entire the magnetizer 80 to magnetize the properties of the fuel and to enhance the fuel vaporization for the prolongation of engine life, the improvement of fuel efficiency, and the deterioration reduction of fuel delivery parts.

Again, all the fuel at the advantageous junction 19 of the outlet end 14 with various the temperatures/extents from the different directions converge and blend together to develop into another steady fuel with another ever-changing specific temperature at another mixing moment because of the design of the magnetizer 80 to greatly reduce the cold and hot spots in the fuel for the device 10. The thermocouple probe 51 at the advantageous junction 19 of the outlet end 14 is constantly detecting the specific temperature of the steady fuel by means of direct contact with the steady fuel at the mixing moment as long as the engine of the automobile is turned on. The probe 51 at the advantageous junction 19 of the outlet end 14 is constantly converting the specific temperature of the steady fuel into an electronic signal to be sent to the integrated circuit 57 as long as the engine of the automobile is turned on. The probe 51 at the advantageous junction 19 of the outlet end 14 with the help of the integrated circuit 57 is also constantly monitoring the specific temperature of the steady fuel to determine whether the specific temperature of the steady fuel is within the preset temperature range or not as long as the engine of the automobile is turned on. The probe 51 at the advantageous junction 19 of the outlet end 14 is constantly/continually repeating the detecting function and the monitoring function unless the engine of the automobile is turned off.

The semiconductor controllers 56 on the circuit board 55 are rapidly activating and deactivating the heating elements 50 and continually repeating the activating function and the deactivating function as long as the engine of the automobile is turned on. If the probe 51 at the advantageous junction 19 of the outlet end 14 is detecting the specific temperature of the steady fuel below the preset temperature range, the controllers 56 on the circuit board 55 will rapidly activate the heating elements 50 as long as the engine of the automobile is turned on. If the probe 51 at the advantageous junction 19 of the outlet end 14 is detecting the specific temperature of the steady fuel above the preset temperature range, the controllers 56 on the circuit board 55 will rapidly deactivate the heating elements 50 as long as the engine of the automobile is turned on. The controllers 56 on the circuit board 55 are rapidly/continually repeating the activating function and the deactivating function unless the engine of the automobile is turned off.

The thermocouple probe 51 at the advantageous junction 19 of the outlet end 14 is constantly/continually detecting and monitoring the temperature of the fuel and the semiconductor controllers 56 on the circuit board 55 are rapidly/continually activating and deactivating the heating elements 50 to lessen, elevate, and maintain the temperature of the fuel as long as the engine of the automobile is turned on. The controllers 56 are rapidly actuating all sets of the heating elements 50 to elevate the temperature of the fuel as soon as the ignition switch of the automobile is started. If the probe 51 is detecting the temperature of the fuel above the preset temperature range, the controllers 56 will rapidly deactivate (all sets except one set)/other sets of the heating elements 50 to lessen/maintain the temperature of the fuel within the preset temperature range as long as the engine of the automobile is turned on. The only one set of the heating elements 50 has been continually working to prevent the temperature of the fuel dropping below the preset temperature range unless the engine of the automobile is turned off. If the probe 51 is detecting the temperature of the fuel below the preset temperature range, the controllers 56 will rapidly activate the other sets of the heating elements 50 to elevate/maintain the temperature of the fuel again within the preset temperature range as long as the engine of the automobile is turned on. The controllers 56 are rapidly/continually repeating the deactivating function to lessen/maintain and rapidly/continually repeating the activating function to elevate/maintain the temperature of the fuel within the preset temperature range unless the engine of the automobile is turned off.

The thermocouple probe 51 at the advantageous junction 19 of the outlet end 14 is constantly/continually detecting and monitoring the temperature of the fuel and the semiconductor controllers 56 and the integrated circuit 57 on the circuit board 55 are rapidly/continually activating and deactivating the heating elements 50 to lessen, elevate, and maintain the temperature of the fuel as long as the engine of the automobile is turned on. The controllers 56 and the integrated circuit 57 on the circuit board 55 are continually elevating the temperature of the fuel by means of activating rapidly and maintaining continually the other sets of the heating elements 50 unless the probe 51 is detecting the temperature of the fuel above the preset temperature range. The probe 51, the controllers 56, and the integrated circuit 57 of the device 10 are repeating constantly/continually the detecting function and the monitoring function and repeating rapidly/continually the activating function and the deactivating function and the elevating function to lessen, elevate, and maintain the temperature of the fuel within the preset temperature range unless the engine of the automobile is turned off. The device 10 under the instruction of the integrated circuit 57 with help of the probe 51 instructs the controllers 56 to activate and deactivate the heating elements 50 and to lessen, elevate, and maintain the temperature of the fuel passing through. These functions performed by the three instruments above as a whole consequently result into two favorable effects: fuel efficiency and pollution reduction.

By strategically selecting the advantageous junction 19 of the outlet end 14 for the thermocouple probe 51 to constantly detect the specific temperature of the steady fuel passing through the magnetizer 80 before final exit of the device 10, any wise person may agree that the detected temperature of the steady fuel should rightfully represent the true temperature of the steady fuel for the device 10. According to the reasoning, the device 10 intelligently adopts the detected temperature of the steady fuel at the advantageous junction 19 of the outlet end 14 as the true temperature of the fuel—a yardstick for the controllers 56 under the instruction of the integrated circuit 57 with the help of the probe 51 to rapidly actuate, deactivate, or activate each set of the heating elements 50 respectively.

In another embodiment shown in FIGS. 4B, 7B, and 8, an alternative fuel magnetizer 80 disposed and attached on the inner wall of the outlet end 14 is to magnetize the properties of the fuel passing from the inner chamber 15 and to enhance fuel vaporization for prolongation of engine life, improvement of fuel efficiency, and deterioration reduction of fuel delivery parts. The magnetizer 80 comprises an outer cylindrical magnetic member 81, an inner cylindrical magnetic member 82, and a tubular sleeve 83. With regard to the disposition, the inner magnetic member 82 is closer to the annular member 30 than the outer magnetic member 81. Both the outer magnetic member 81 and the inner magnetic member 82 are made of Nd—Fe—B permanent magnet, whereas the tubular sleeve 83 is made of fuel resistance materials.

The outer magnetic member 81 has four keyways 90A around the external cylindrical surface of the outer magnetic member 81 to be inserted into by four respective splines 89A of the tubular sleeve 83 correspondingly. The inner magnetic member 82 has four keyways 90B around the external cylindrical surface of the inner magnetic member 82 to be inserted into by four respective splines 89B of the tubular sleeve 83 correspondingly. The outer magnetic member 81 has four round passage holes 86A to allow the fuel to exit out the magnetizer 80 and five cylinder projections 87A to extend into the corresponding round passage holes 86B of the inner magnetic member 82 to create magnetic fields within the passage holes 86B. The inner magnetic member 82 has five round passage holes 86B to allow the fuel to enter into the magnetizer 80 and four cylinder projections 87B to extend into the corresponding round passage holes 86A of the outer magnetic member 81 to create magnetic fields within the passage holes 86A. The identical diameter of each round passage hole 86 in terms of length is exactly twice long as the identical diameter of each cylinder projection 87 for both the outer magnetic member 81 and the inner magnetic member 82.

The tubular sleeve 83 has an attached annulus 95 over the center portion of the internal surface of the tubular sleeve 83. The tubular sleeve 83 has two respective splines 89A over one side of the internal surface of the tubular sleeve 83 to insert into the keyways of the outer magnetic member 81 correspondingly. The tubular sleeve 83 has two respective splines 89B over other side of the internal surface of the tubular sleeve 83 to insert into the keyways of the inner magnetic member 82 correspondingly. The annulus 95 is for separating the outer magnetic member 81 from the inner magnetic member 82 to define a cavity 85 with a magnetic field within the cavity 85 because of Nd—Fe—B permanent magnet. The annulus 95 is extending from the internal surface of the tubular sleeve 83 into the cavity 85. The cavity 85 between the outer magnetic member 81 and the inner magnetic member 82 provides excessive fuel flowing from the inner magnetic member 82 to be accumulated and to be treated there by a magnetic field generated by said Nd—Fe—B permanent magnet prior to entrance into the outer magnetic member 81.

The magnetizer 80 utilizes the splines 96A and 96B and keyways 97A and 97B to hold the tubular sleeve 83, the outer magnetic member 81, and the inner magnetic member 82 as a cohesive unit. The magnetic fields within the passage holes 86B of the outer magnetic member 81, the cavity 85, and the passage holes 86A of the inner magnetic member 82 develop a magnetic flow path for the fuel throughout entire the magnetizer 80 to magnetize the properties of the fuel and to enhance the fuel vaporization for the prolongation of engine life, the improvement of fuel efficiency, and the deterioration reduction of fuel delivery parts.

Both the electrical circuit board 55 and the housing means 12 are mounted over the holding base 40 on the automobile. The fuel heating device 10 is suitable for all types of fuels: regular gasoline, premium gasoline, ethanol gasoline, methanol gasoline, diesel fuel, emulsified fuel, and composite fuel. Each type of the fuels has its own preset temperature range for efficient combustion in the engine.

### OPERATION OF THE INVENTION

The preferred embodiment of a fuel heating device 10 for an internal combustion engine (not shown) in an automobile (not shown) for fuel efficiency and pollution reduction described and depicted above can be moreover delineated from the standpoint of its operation. When an ignition switch (not shown) in the automobile is turned on, a battery (not shown) in the automobile is to provide electrical current to all sets of electrical heating elements 50.

There are at least two or a plurality of sets of the electrical heating elements 50 made of heat resistance materials and regulated by semiconductor controllers 56. All sets of the heating elements 50 are adjoined and touched together all the time and attached firmly on the inner wall of a spiral, electrical heating pipe 20. All sets of the heating elements 50 are encircling and winding extensively within the internal room of the heating pipe 20 to spread large contact regions for the heating pipe 20 and to rapidly generate and conduct electrical heat. The objective to dispose all sets of the heating elements 50 within the heating pipe 20 is to avoid direct contact with a fuel passing through for safety concerns. The heating elements 50 are to rapidly generate and conduct the electrical heat for rapidly elevating the temperature of the heating pipe 20 by means of direct contact with the heating pipe 20 via thermal conduction.

An infrared annular member 30 is in the center portion of an inner chamber 15 between an inlet end 13 and an outlet end 14. The infrared annular member 30 elongated in shape and made of heat retaining materials can be divided into two different segments. The big segment is in small dimension at size 30A with its one side near the inlet end 13. The small segment is in large dimension at size 30B with its other side near the outlet end 14. The annular member 30 has an interior passageway 16 to rapidly elevate the temperature of the fuel passing through from the inlet end 13 by means of direct contact via thermal conduction. The reason for the annular member 30 made of heat retaining materials is to gradually release the heat of the annular member 30 to the heating pipe 20 and to filling metal gauzes 36. The annular member 30 can maintain temperature stability within the inner chamber 15 by gradually releasing the retaining heat of the annular member 30 slowly.

Wrapping and winding around the outside surface of the big segment in small dimension at size 30A of the annular member 30 near the inlet end 13, there is the spiral heating pipe 20. The reason for the heating pipe 20 made of heat conduction materials is to rapidly conduct the electrical heat from the heating pipe 20 to the annular member 30 and to the filling metal gauzes 36. The reason for the spiral heating pipe 20 wrapping around the outside surface of the annular member 30 is to rapidly elevate the temperature of the annular member 30 and the temperature of the interior passageway 16 by means of direct and indirect contact via thermal conduction. The major purposes for the spiral heating pipe 20 to wrap around the outside surface of the annular member 30 near the inlet end 13 are to spread large contact regions for the annular member 30 and to promote heat conduction from the heating pipe 20 to the annular member 30. The minor purpose to wrap around the annular member 30 is to hold the annular member 30 in a firm and stable position within the inner chamber 15.

The heating pipe 20 safely enters into a housing means 12 from (an entering)/one position 21A near the inlet end 13 and safely exits out the housing means 12 from (an exiting) another position 21B near the outlet end 14. Both the positions 21A and 21B of the heating pipe 20 are fixed and sealed safely with the housing means 12 by threaded engagements (not shown) to prevent unnecessary fuel leakages. Besides the internal room of the heating pipe 20 occupied by the heating elements 50, other internal room of the heating pipe 20 is occupied with stuffing gauzes (not shown) made of magnesium oxide with heat conduction and electricity insulation in nature. The stuffing gauzes can insulate electrically all sets of the heating elements 50 and hold all sets of the heating elements 50 in their firm, stable, and respective positions. The stuffing gauzes can evenly conduct the electrical heat from the heating elements 50 to the heating pipe 20 by means of direct contact via thermal conduction. The heating elements 50 and the stuffing gauzes both within the heating pipe 20 can rapidly and evenly generate and conduct the electrical heat from the heating elements 50 to the heating pipe 20 and rapidly and evenly elevate the temperature of the heating pipe 20 via thermal conduction by means of direct contact with the heating pipe 20.

The housing means 12 made of rigid materials defines the inner chamber 15 with the inlet end 13 at one side, with the outlet end 14 at other side, and with the inner chamber 15 in the middle. The inlet end 13 is connected with a fuel pipe (not shown) from a fuel tank (not shown) in the automobile and the outlet end 14 is connected with the engine in the automobile with the device 10 in between. The fuel heating device 10 utilizes the housing means 12 to establish a flow path for the fuel traveling throughout the inner chamber 15 from the inlet end 13 to the outlet end 14 to elevate the temperature of the fuel and to improve the properties of the fuel for the engine in the automobile.

The heat of the heating pipe 20 is to rapidly elevate the temperature of the annular member 30, the temperature of the interior passageway 16, and the temperature of the filling metal gauzes 36 within the inner chamber 15 via thermal conduction by means of direct and indirect contact with the heating pipe 20. The heat of annular member 30 is to rapidly elevate the temperature of the interior passageway 16 and the temperature of the filling metal gauzes 36 via thermal conduction by means of direct and indirect contact with the annular member 30. The heat of the heating pipe 20 and the annular member 30 is to rapidly elevate the temperature of the filling metal gauzes 36 via thermal conduction by means of direct and indirect contact with the heating pipe 20 and the annular member 30.

The filling metal gauzes 36 can absorb the heat diffused from the heating pipe 20 and the annular member 30 for elevating the temperature of the fuel via thermal conduction by means of direct contract with the fuel passing through. The filling metal gauzes 36 can hold the annular member 30 in a firm and stable position within the inner chamber 15. The heating pipe 20, the annular member 30, and the filling metal gauzes 36 all within the inner chamber 15 of the housing means 12 constitute three thermal exchangers for the device 10. The three thermal exchangers are to promote thermal conduction one another within the inner chamber 15 and to rapidly elevate the temperature of the fuel passing through via thermal conduction by means of direct contact with the three thermal exchangers. The heating pipe 20 and the annular member 30 and/including the interior passageway 16 and the filling metal gauzes 36 fully exploit the electrical heat generated by the heating elements 50 to rapidly elevate the temperature of the fuel via thermal conduction by means of direct contact with the fuel traveling throughout the inner chamber 15 from the inlet end 13 to the outlet end 14 to establish the flow path of the fuel to be elevated in the temperature and to be treated in the properties.

The heating elements 50 and the stuffing gauzes rapidly and evenly generate and conduct the electrical heat by means of direct contact via thermal conduction to elevate the temperatures of the three thermal exchangers. The device 10 is to rapidly conduct, elevate, and maintain the temperature of the fuel traveling throughout the inner chamber 15 from the inlet end 13 to the outlet end 14 to various temperatures/extents via thermal conduction by means of direct contact with the three thermal exchangers and the interior passageway 16 of the annular member 30. The heating pipe 20 and the outside surface of the annular member 30 receive maximum extent of the electrical heat generated by the heating elements 50 by means of direct contact via thermal conduction. The interior passageway 16 of the annular member 30 receives medium extent of the electrical heat generated by the heating elements 50 by means of direct contact via thermal conduction. The filling metal gauzes 36 receive minimum extent of the electrical heat generated by the heating elements 50 by means of direct and indirect contact via thermal conduction.

The three thermal exchangers are to rapidly elevate and maintain the temperature of the fuel passing through to the maximum extent via thermal conduction by means of direct contact with the heating pipe 20 and the outside surface of the annular member 30. The three thermal exchangers are to rapidly elevate and maintain the temperature of the fuel passing through to the medium extent via thermal conduction by means of direct contact with the interior passageway 16 of the annular member 30. The three thermal exchangers are to merely elevate and maintain the temperature of the fuel passing through to the minimum extent via thermal conduction by means of direct contact solely with the filling metal gauzes 36. The fuel heating device 10 for the engine of the automobile is to rapidly conduct, elevate, and maintain the temperature of the fuel traveling throughout the inner chamber 15 from the inlet end 13 to the outlet end 14 to various the temperatures/extents via thermal conduction by means of direct contact with the three thermal exchangers of the electrical heating pipe 20 and the infrared annular member 30 and the filling metal gauze 36 and/including the interior passageway 16 of the annular member 30 all within the inner chamber 15 of the housing means 12.

The three thermal exchangers of the heating pipe 20, the annular member 30 and/including the interior passageway 16, and the filling metal gauzes 36 are to fully exploit the electrical heat generated by the heating elements 50 via thermal conduction by means of direct contact with the thermal exchangers, to promote thermal conduction one another within the inner chamber 15, and to rapidly elevate the temperature of the fuel passing through. The device 10 fully exploits the electrical heat generated by the electrical heating elements 50 to rapidly and evenly conduct, elevate, and maintain the temperature of the fuel traveling throughout the inner chamber 15 from the inlet end 13 to the outlet end 14 via thermal conduction by means of direct contact with the three thermal exchangers. The three thermal exchangers of the heating pipe 20 and the annular member 30 and the filling metal gauzes 36 along with the electrical heating elements 50 and the stuffing gauzes, are to rapidly and evenly generate and conduct the electrical heat and to rapidly elevate and maintain the temperature of the fuel traveling throughout the inner chamber 15 from the inlet end 13 to the outlet end 14 to various the temperatures/extents by means of direct contact via thermal conduction.

Throughout rapidly generating the electrical heat by the heating elements 50, evenly conducting the generating heat by the stuffing gauzes, rapidly conducting the generating heat by the three thermal exchangers, and gradually releasing the retaining heat by the annular member 30, the device 10 is capable of having maintained the temperature stability within the inner chamber 15. Even after the ignition switch of the automobile is turned off, the annular member 30 can still maintain the temperature stability within the inner chamber 15 for a long period of time because of the heat retaining nature of the annular member 30.

The device 10 is also able to improve the properties of the fuel by sintering a multi-metallic layer 32 on the outside surface of the annular member 30 and by providing a plurality of multi-elements plates 38 made of catalysis materials and disposed within the inner chamber 15. Both the multi-elements plates 38 and the multi-metallic layer 32 are capable of performing a catalysis process to improve the properties of the fuel by restoring the fuel back to the original stage at refinery level before delivery to gas stations without bad influences of adding fuel additives. On the outer surface of the heating pipe 20, there is sprayed with a nanometer-level ceramic coating 22 to lessen the extent of thermal conduction between the heating pipe 20 and the fuel passing through for safety concerns and to prevent the fuel passing through in direct contact with the outer surface of the heating pipe 20 from overheating.

The device 10 provides a fuel stabilizer 60 disposed and attached on the inner wall of the inlet end 13 to regulate the flow and the pressure of the fuel passing from the fuel tank in the automobile to a constantly balancing level upon initial entrance into the device 10. The stabilizer 60 is to avoid any unnecessary, excessive fuel supply waste in combustion chambers (not shown) in the engine. The fuel heating device 10 also provides a or an alternative fuel magnetizer 80 disposed and attached on the inner wall of the outlet end 14 to magnetize the properties of the fuel passing from the inner chamber 15 and to enhance fuel vaporization for prolongation of engine life, improvement of fuel efficiency, and deterioration reduction of fuel delivery parts.

The fuel heating device 10 has a thermocouple probe 51 connected with the semiconductor controllers 56 and an integrated circuit 57 both on an electrical circuit board 55, and all further connected with the battery in the automobile before the fuel finally exits out the device 10. When the fuel at ambient temperature supplied by a fuel pump (not shown) is traveling into the device 10 from the inlet end 13, the probe 51 at an advantageous junction 19 of the outlet end 14 is constantly detecting an ever-changing specific temperature of a steady fuel by means of direct contact with the steady fuel at a mixing moment. The semiconductor controllers 56 and the integrated circuit 57 both on the electrical circuit board 55 are further connected with the battery in the automobile. Three instruments of the probe 51, the integrated circuit 57, and the controllers 56 are important components of an electrical system for the device 10.

All fuel at the advantageous junction 19 of the outlet end 14 with various the temperatures/extents from different directions converge and blend together to develop into the steady fuel with the specific temperature at the mixing moment because of the design of the magnetizer 80 to greatly reduce cold and hot spots in the fuel for the device 10. The thermocouple probe 51 at the advantageous junction 19 of the outlet end 14 is constantly detecting the specific temperature of the steady fuel by means of direct contact with the steady fuel at the mixing moment as long as the engine of the automobile is turned on. The probe 51 at the advantageous junction 19 of the outlet end 14 is constantly converting the specific temperature of the steady fuel into an electronic signal to be sent to the integrated circuit 57 as long as the engine of the automobile is turned on. The probe 51 at the advantageous junction 19 of the outlet end 14 with the help of the integrated circuit 57 is also constantly monitoring the specific temperature of the steady fuel to determine whether the specific temperature of the steady fuel is within a preset temperature range or not as long as the engine of the automobile is turned on. The probe 51 at the advantageous junction 19 of the outlet end 14 is constantly/continually repeating the detecting function and the monitoring function unless the engine of the automobile is turned off.

The semiconductor controllers 56 on the circuit board 55 are rapidly activating and deactivating the heating elements 50 and continually repeating the activating function and the deactivating function as long as the engine of the automobile is turned on. If the probe 51 at the advantageous junction 19 of the outlet end 14 is detecting the specific temperature of the steady fuel below the preset temperature range, the controllers 56 on the circuit board 55 will rapidly activate the heating elements 50 as long as the engine of the automobile is turned on. If the probe 51 at the advantageous junction 19 of the outlet end 14 is detecting the specific temperature of the steady fuel above the preset temperature range, the controllers 56 on the circuit board 55 will rapidly deactivate the heating elements 50 as long as the engine of the automobile is turned on. The controllers 56 on the circuit board 55 are rapidly/continually repeating the activating function and the deactivating function unless the engine of the automobile is turned off.

The thermocouple probe 51 at the advantageous junction 19 of the outlet end 14 is constantly/continually detecting and monitoring the temperature of the fuel and the semiconductor controllers 56 on the circuit board 55 are rapidly/continually activating and deactivating the heating elements 50 to lessen, elevate, and maintain the temperature of the fuel as long as the engine of the automobile is turned on. The controllers 56 are rapidly actuating all sets of the heating elements 50 to elevate the temperature of the fuel as soon as the ignition switch of the automobile is started. If the probe 51 is detecting the temperature of the fuel above the preset temperature range, the controllers 56 will rapidly deactivate (all sets except one set)/other sets of the heating elements 50 to lessen/maintain the temperature of the fuel within the preset temperature range as long as the engine of the automobile is turned on. The only one set of the heating elements 50 has been continually working to prevent the temperature of the fuel dropping below the preset temperature range unless the engine of the automobile is turned off. If the probe 51 is detecting the temperature of the fuel below the preset temperature range, the controllers 56 will rapidly activate the other sets of the heating elements 50 to elevate/maintain the temperature of the fuel again within the preset temperature range as long as the engine of the automobile is turned on. The controllers 56 are rapidly/continually repeating the deactivating function to lessen/maintain and rapidly/continually repeating the activating function to elevate/maintain the temperature of the fuel within the preset temperature range unless the engine of the automobile is turned off.

The thermocouple probe 51 at the advantageous junction 19 of the outlet end 14 is constantly/continually detecting and monitoring the temperature of the fuel and the semiconductor controllers 56 and the integrated circuit 57 on the circuit board 55 are rapidly/continually activating and deactivating the heating elements 50 to lessen, elevate, and maintain the temperature of the fuel as long as the engine of the automobile is turned on. The controllers 56 and the integrated circuit 57 on the circuit board 55 are continually elevating the temperature of the fuel by means of activating rapidly and maintaining continually the other sets of the heating elements 50 unless the probe 51 is detecting the temperature of the fuel above the preset temperature range. The probe 51, the controllers 56, and the integrated circuit 57 of the device 10 are repeating constantly/continually the detecting function and the monitoring function and repeating rapidly/continually the activating function and the deactivating function and the elevating function to lessen, elevate, and maintain the temperature of the fuel within the preset temperature range unless the engine of the automobile is turned off. The device 10 under the instruction of the integrated circuit 57 with help of the probe 51 instructs the controllers 56 to activate and deactivate the heating elements 50 and to lessen, elevate, and maintain the temperature of the fuel passing through.

By strategically selecting the advantageous junction 19 of the outlet end 14 for the thermocouple probe 51 to constantly detect the specific temperature of the steady fuel passing through the magnetizer 80 before final exit of the device 10, any wise person may agree that the detected temperature of the steady should rightfully represent a true temperature in the fuel for the device 10. According to this reasoning, the device 10 intelligently adopts the detected temperature of the fuel at the advantageous junction 19 of the outlet end 14 as the true temperature in the fuel—a yardstick for the controllers 56 under the instruction of the integrated circuit 57 with the help of the probe 51 to rapidly actuate, deactivate, or activate each set of the electrical heating elements 50 respectively.

Both the electrical circuit board 55 and the housing means 12 are mounted over a holding base 40 on the automobile. The fuel heating device 10 is suitable for all types of fuels: regular gasoline, premium gasoline, ethanol gasoline, methanol gasoline, diesel fuel, emulsified fuel, and composite fuel. Each type of the fuels has its own preset temperature range for efficient combustion in the engine.

Accordingly, while this invention has been described with reference to the illustrative embodiment, none should intend to interpret the description in a limiting or narrow sense regarding its scope. Various ramifications, variations, and modifications of the illustrative embodiment will be apparent to those people skilled in the art upon reference to the description. It is therefore contemplated that the appended claims and their legal equivalents will cover any aforesaid ramifications, variations, and modifications within the true scope of the invention.

I claim:

1. A fuel heating device for fuel efficiency and pollution reduction is to elevate the temperature of a fuel and improve the properties of said fuel for an internal combustion engine in an automobile, comprising:
a) a housing means made of rigid materials, defining an inner chamber, an inlet end connected with a fuel pipe from a fuel tank in said automobile, and an outlet end connected with said engine in said automobile to establish a flow path for said fuel traveling throughout said inner chamber from said inlet end to said outlet end;
b) an infrared annular member made of heat retaining materials in the center portion of said inner chamber having an interior passageway to rapidly elevate said temperature of said fuel passing through from said inlet end; and
c) a spiral, electrical heating pipe made of heat conduction materials wrapping and winding around the outside surface of the big segment in small dimension at size of said annular member, said heating pipe having a plurality of sets of electrical heating elements made of heat resistance materials, said heating elements encircling and winding extensively within the internal room of said heating pipe to spread large contact regions for said heating pipe and to rapidly generate and conduct electrical heat and to rapidly elevate the temperature of said heating pipe, the heat of said heating pipe rapidly elevating the temperature of said annular member and the temperature of said interior passageway by means of direct and indirect contact via thermal conduction, and said heating pipe and said annular member and said interior passageway rapidly elevating said temperature of said fuel via thermal conduction by means of direct contact with said fuel traveling throughout said inner chamber from said inlet end to said outlet end,
whereby said heating pipe and said annular member and said interior passageway fully exploit said electrical heat generated by said heating elements to rapidly elevate said temperature of said fuel via thermal conduction by means of direct contact with said fuel traveling throughout said inner chamber from said inlet end to said outlet end to establish a flow path for said fuel to be elevated in said temperature and be treated in said properties.

2. The electrical heating pipe according to claim 1, further including at least two sets of said heating elements being disposed within said heating pipe for safety concerns, all sets of said heating elements being attached firmly on the inner wall of said heating pipe and regulated by semiconductor controllers, all said sets of said heating elements being adjoined and touched together all the time to rapidly generate and conduct said electrical heat and to rapidly elevate said temperature of said heating pipe by means of direct contact with said heating pipe via thermal conduction, said heating pipe safely entering into said housing means from one position near said inlet end and safely exiting out said housing means from another position near said outlet end, and both said positions of said heating pipe being fixed and sealed safely with said housing means by threaded engagements to prevent unnecessary fuel leakages.

3. The electrical heating pipe according to claim 1, wherein besides the internal room of said heating pipe occupied by said heating elements, other internal room being occupied with stuffing gauzes made of magnesium oxide with heat-conduction and electricity-insulation in nature, said stuffing gauzes holding all said sets of said heating elements in firm, stable, and respective positions to evenly conduct said electrical heat from said heating elements to said heating pipe by means of direct contact via thermal conduction and to electrically insulate all said sets of said heating elements, and said heating elements and said stuffing gauzes both within said heating pipe rapidly and evenly generating and conducting said electrical heat from said heating elements to said heating pipe and rapidly and evenly elevating said temperature of said heating pipe via thermal conduction by means of direct contact with said heating pipe.

4. The electrical heating pipe according to claim 1, wherein on the outer surface of said heating pipe being sprayed with a nanometer-level ceramic coating to lessen the extent of thermal conduction between said heating pipe and said fuel passing through for safety concerns and to prevent said fuel passing through in direct contact with said outer surface of said heating pipe from overheating.

5. The inner chamber according to claim 1, further including a plurality of multi-elements plates being made of catalysis materials and disposed within said inner member and a multi-metallic layer being sintered on the outside surface of said annular member, and said multi-elements plates and said multi-metallic layer being capable of performing a catalysis process to improve said properties of said fuel for efficient combustion by restoring said fuel back to the original stage at refinery level before delivery to gas stations without bad influences of adding fuel additives.

6. The inner chamber according to claim 1, further including filling metal gauzes absorbing said heat diffused from said heating pipe and said annular member for elevating said temperature of said fuel via thermal conduction by means of direct contact with said fuel passing through and holding said annular member in a firm and stable position within said inner chamber.

7. The infrared annular member according to claim 1, wherein wrapping around the outside surface of said annular member near said inlet end by said spiral heating pipe, to rapidly elevate said temperature of said annular member and said temperature of said interior passageway by means of direct and indirect contact via thermal conduction, to spread large contact regions for said annular member, to promote heat conduction from said heating pipe to said annular member, and to hold said annular member in a firm and stable position within said inner chamber.

8. The fuel heating device according to claim 1, further including a thermocouple probe at said outlet end, said housing means over a holding base on said automobile, and semiconductor controllers and an integrated circuit both on an electrical circuit board over said holding base on said automobile.

9. The fuel heating device according to claim 1, wherein being suitable for all types of fuels: regular gasoline, premium gasoline, ethanol gasoline, methanol gasoline, diesel fuel, emulsified fuel, and composite fuel, and each type of said fuels having a preset temperature range for efficient combustion in said engine.

10. The fuel heating device according to claim 1, further including a fuel stabilizer disposed and attached on the inner wall of said inlet end to regulate the flow and the pressure of said fuel passing from said fuel tank in said automobile to a constantly balancing level upon initial entrance into said device and to avoid any unnecessary, excessive fuel supply waste in combustion chambers in said engine, comprising:
a) a cup-shaped inlet casing means and a cup-shaped outlet casing means, both being made of stiff materials and being disposed and attached on said inner wall of said inlet end
b) and being clamped together to form an enclosure, said inlet casing means further having an inlet orifice in the center portion of said inlet casing means normally to permit said fuel passing from said fuel tank to enter into said stabilizer, and said outlet casing means further having a plurality of outlet apertures in the center portion of said outlet casing means always to permit said fuel passing from said enclosure to enter into said inner chamber of said device;
c) a u-shaped large piston in said enclosure, the bottom part of said large piston being close and parallel to the inner wall of said inlet casing means, said large piston having a plurality of inlet apertures in the center portion of said large piston normally to permit said fuel passing from said inlet orifice to enter into said enclosure and sometimes said large piston to deny some flow passage of said fuel passing from said inlet orifice to enter into said enclosure when said large piston is to perform a moving function toward said inlet casing means to block some flow passage of said fuel passing from said inlet orifice to enter into said enclosure;
d) a large compression spring, being disposed and extended between said large piston and said outlet casing means, one side of said compression spring being attached to the inner wall of said large piston, whereas the other side of said compression spring being attached to the inner wall of said outlet casing means to provide a restraining force to push said large piston toward said inlet casing means;
e) a u-shaped small piston in said enclosure being disposed in the pocket of said large piston, the bottom part of said small piston being close and parallel to said bottom part of said large piston, and said small piston being normally to permit said fuel passing
f) from said inlet apertures to enter into said enclosure and sometimes said small piston to deny some flow passage of said fuel passing from said inlet apertures to enter into said enclosure when said small piston is to perform a moving function toward said large piston to block some flow passage of said fuel passing from said inlet apertures to enter into said enclosure; and
g) a small tension spring being disposed and extended between said small piston and said outlet casing means, one side of said tension spring being attached to the inner wall of said small piston, whereas the other side of said tension spring being attached to said inner wall of said outlet casing means to provide a restraining force to push said small piston toward said large piston.
whereby said stabilizer fully utilizing said restraining force of said compression spring and said restraining force of said tension spring in accompanying with said moving function of said large piston and said moving function of said small piston to block some flow passage of said fuel in order to achieve said constantly balancing level for said flow and said pressure of said fuel passing through and to avoid said unnecessary, excessive fuel supply waste in said combustion chambers in said engine.

11. The fuel heating device according to claim 1, further including a fuel magnetizer disposed and attached on the inner wall of said outlet end to magnetize said properties of said fuel passing from said inner chamber and to enhance fuel vaporization for prolongation of engine life, improvement of fuel efficiency, and deterioration reduction of fuel delivery parts, comprising:
a) an outer cylindrical magnetic member having a plurality of keyways around the external cylindrical surface of said outer magnetic member to be inserted into by a plurality of respective splines of a tubular sleeve correspondingly and an inner cylindrical magnetic member having a plurality of keyways around the external cylindrical surface of said inner magnetic member to be inserted into by a plurality of respective splines of said tubular sleeve correspondingly, both said outer magnetic member and said inner magnetic member being made of Nd—Fe—B permanent magnet, and said outer magnetic member having a plurality of round passage holes to allow said fuel to exit out said magnetizer and a plurality of cylinder projections to extend into the corresponding round passage holes of said inner magnetic member to create magnetic fields within said passage holes and said inner magnetic member having a plurality of round passage holes to allow said fuel to enter into said magnetizer and a plurality of cylinder projections to extend into the corresponding said round passage holes of said outer magnetic member to create magnetic fields within said passage holes;
b) said tubular sleeve made of fuel resistance materials having a plurality of respective splines over the center portion of the internal surface of said tubular sleeve to insert into a plurality of keyways of a spacer ring, having a plurality of respective splines over one side of said internal surface of said tubular sleeve to insert into said keyways of said outer magnetic member correspondingly, and having a plurality of respective splines over other side of said internal surface of said tubular sleeve to insert into said keyways of said inner magnetic member correspondingly;
c) said spacer ring made of said fuel resistance materials and disposed in the center portion of said magnetizer, having a plurality of keyways around the external ring surface of said spacer ring to allow respective said splines over said center portion of said internal surface of said tubular sleeve to be inserted into, separating said outer magnetic member from said inner magnetic member for defining a cavity with a magnetic field within said cavity because of Nd—Fe—B permanent magnet, and said cavity between said outer magnetic member and said inner magnetic member providing excessive fuel flowing from said inner magnetic member to be accumulated and to be treated there by a magnetic field generated by said Nd—Fe—B permanent magnet prior to entrance into said outer magnetic member,
whereby said magnetizer utilizing said splines and said keyways to hold said tubular sleeve, and said spacer ring, said outer magnetic members, and said inner magnetic members as a cohesive unit, said magnetic fields within said passage holes of said outer magnetic member, said cavity, and said passage holes of said inner magnetic member developing a magnetic flow path for said fuel throughout entire said magnetizer to magnetize said properties of said fuel and to enhance said fuel vaporization for said prolongation of engine life, said improvement of fuel efficiency, and said deterioration reduction of fuel delivery parts.

12. The fuel heating device according to claim 1, further including an alternative fuel magnetizer disposed and attached on the inner wall of said outlet end to magnetize said properties of said fuel passing from said inner chamber and to enhance fuel vaporization for prolongation of engine life, improvement of fuel efficiency, and deterioration reduction of fuel delivery parts, comprising:
a) an outer cylindrical magnetic member having a plurality of keyways around the external cylindrical surface of said outer magnetic member to be inserted into by a plurality of respective splines of a tubular sleeve correspondingly and an inner cylindrical magnetic member having a plurality of keyways around the external cylindrical surface of said inner magnetic member to be inserted into by a plurality of respective splines of said tubular sleeve correspondingly, both said outer magnetic member and said inner magnetic member being made of Nd—Fe—B permanent magnet, and said outer magnetic member having a plurality of round passage holes to allow said fuel to exit out said magnetizer and a plurality of cylinder projections to extend into the corresponding round passage holes of said inner magnetic member to create magnetic fields within said passage holes and said inner magnetic member having a plurality of round passage holes to allow said fuel to enter into said magnetizer and a plurality of cylinder projections to extend into corresponding the round passage holes of said outer magnetic member to create magnetic fields within said passage holes;
b) said tubular sleeve made of fuel resistance materials having an attached annulus over the center portion of the internal surface of said tubular sleeve, having two respective splines over one side of said internal surface of said tubular sleeve to insert into said keyways of said outer magnetic member correspondingly and having two respective splines over other side of said internal surface of said tubular sleeve to insert into said keyways of said inner magnetic member correspondingly, said annulus separating said outer magnetic member from said inner magnetic member to define a cavity with a magnetic field within said cavity because of Nd—Fe—B permanent magnet and extending from said internal surface of said tubular sleeve into said cavity, and said cavity providing excessive fuel flowing from said inner magnetic member to be accumulated and to be treated there by a magnetic field generated by said Nd—Fe—B permanent magnet prior to entrance into said outer magnetic member,
whereby said magnetizer utilizing said splines and said keyways to hold said tubular sleeve, said outer magnetic members, and said inner magnetic members as a cohesive unit, and said magnetic fields within said passage holes of said outer magnetic member, said cavity, and said passage holes of said inner magnetic member developing a magnetic flow path for said fuel throughout entire said magnetizer to magnetize said properties of said fuel and to enhance said fuel vaporization for said prolongation of engine life, said improvement of fuel efficiency, and said deterioration reduction of fuel delivery parts.

13. A fuel heating device for an internal combustion engine in an automobile to rapidly conduct, elevate, and maintain the temperature of a fuel traveling throughout an inner chamber from an inlet end to an outlet end to various temperatures/extents via thermal conduction by means of direct contact with three thermal exchangers of an electrical heating pipe and an infrared annular member and filling metal gauzes including the interior passageway of said annular member all within said inner chamber of a housing means by the following formats:
a) elevating and maintaining rapidly said temperature of said fuel passing through to maximum extent via thermal conduction by means of direct contact with said heating pipe of said thermal exchangers and the outside surface of said annular member of said thermal exchangers;
b) elevating and maintaining rapidly said temperature of said fuel passing through to medium extent via thermal conduction by means of direct contact with said interior passageway of said annular member; and
c) elevating and maintaining merely said temperature of said fuel passing through to minimum extent via thermal conduction by means of direct contact solely with said filling metal gauzes of said thermal exchangers,
whereby said device is to rapidly conduct, elevate, and maintain said temperature of said fuel traveling throughout said inner chamber from said inlet end to said outlet end to various said temperatures/extents via thermal conduction by means of direct contact with said three thermal exchangers and said interior passageway of said annular member.

14. The three thermal exchangers of said heating pipe and said annular member and said filling metal gauzes according to claim 13, wherein along with electrical heating elements and stuffing gauzes rapidly and evenly generating and conducting electrical heat, rapidly elevating and maintaining said temperature of said fuel traveling throughout said inner chamber from said inlet end to said outlet end to various said temperatures/extents by means of direct contact via thermal conduction by the following procedures:
a) rapidly elevating said temperature of said heating pipe made of heat conduction materials via thermal conduction by means of direct contact with at least two sets of said heating elements adjoined and touched together all the time, said heating elements being made of heat resistance materials and regulated by semiconductor controllers and encircling and winding extensively within the internal room of said
b) heating pipe to spread large contact regions for said heating pipe and to rapidly generate and conduct said electrical heat;
c) rapidly and evenly elevating said temperature of said heating pipe via thermal conduction by means of direct contact with said heating elements and said stuffing gauzes made of magnesium oxide with heat conduction and electricity insulation in nature, both within said heating pipe for rapidly and evenly generating and conducting said electrical heat from said heating elements to said heating pipe by means of direct contact via thermal conduction, and said stuffing gauzes holding all sets of said heating elements in firm, stable, and respective positions and insulating electrically all sets of said heating elements;
d) rapidly elevating said temperature of said annular member made of heat retaining materials via thermal conduction by means of direct contact with said heating pipe and wrapping and winding around the outside surface of the big segment in small dimension at size of said annular member by said spiral heating pipe to spread large contact regions for said annular member and to promote heat conduction from said heating pipe to said annular member;
e) rapidly elevating said temperature of said filling metal gauzes via thermal conduction by means of direct and indirect contact with said heating pipe and said annular member, and said filling metal gauzes holding said annular member in a firm and stable position within said inner chamber;
f) rapidly elevating said temperature of said fuel passing through via thermal conduction by means of direct contact with said three thermal exchangers to
g) promote thermal conduction one another within said inner chamber and to fully exploit said electrical heat generated by said heating elements; and
h) rapidly generating said electrical heat by said heating elements, evenly conducting said generating heat by said stuffing gauzes, rapidly conducting said generating heat by said three thermal exchangers, gradually releasing the retaining heat by said annular member, and said device being capable of having maintained temperature stability within said inner chamber,
whereby said heating elements and said stuffing gauzes rapidly and evenly generating and conducting said electrical heat by means of direct and indirect contact via thermal conduction to rapidly elevate said temperatures of said thermal exchangers, said device rapidly conducting, elevating, and maintaining said temperature of said fuel traveling throughout said inner chamber from said inlet end to said outlet end to various said temperatures/extents via thermal conduction by means of direct contact with said three thermal exchangers and said interior passageway of said annular member, from said maximum extent of said heating pipe and said outside surface of said annular member, to said medium extent of said interior passageway of said annular member, and to said minimum extent of said filling metal gauzes, and throughout rapidly generating said electrical heat by said heating elements, evenly conducting said generating heat by said stuffing gauzes, rapidly conducting said generating heat by said thermal exchangers, and gradually releasing said retaining heat by said annular member, said device being capable of having maintained said temperature stability within said inner chamber because of the heat retaining nature of said annular member for a long period of time even after the ignition switch of said automobile is turned off.

15. The fuel heating device according to claim 14, wherein all said fuel at the advantageous junction of said outlet end with various said temperatures/extents from different directions converging and blending together to develop into a steady fuel with an ever-changing specific temperature at a mixing moment because of the design of said magnetizer to greatly reduce cold and hot spots in said fuel for said device, strategically selecting the advantageous junction of said outlet end for a thermocouple probe to constantly detect said specific temperature of said steady fuel passing through a fuel magnetizer before final exit of said device, and intelligently adopting said detected temperature of said steady fuel as a yardstick for said controllers under the instruction of an integrated circuit with the help of said probe to rapidly actuate, deactivate, or activate each set of said heating elements respectively.

16. A fuel heating device has a thermocouple probe connected with semiconductor controllers and an integrated circuit both on an electrical circuit board further connected with a battery in an automobile, strategically selecting an advantageous junction of an outlet end for said probe to constantly detect an ever-changing specific temperature of a steady fuel passing through a magnetizer before final exit of said device, said detected temperature of said steady fuel rightfully representing true temperature of said steady fuel for said device, and said device intelligently adopting said detected temperature of said fuel as a yardstick for said controllers under the instruction of said integrated circuit with the help of said probe to rapidly actuate, deactivate, or activate each set of electrical heating elements respectively.

17. The thermocouple probe at said advantageous junction of said outlet end according to claim 16, wherein constantly detecting and monitoring said specific temperature of said steady fuel by means of direct contact with said steady fuel at a mixing moment and constantly/continually repeating said detecting function and said monitoring function as long as the engine of the automobile is turned on as follows:
a) detecting constantly said specific temperature of said steady fuel and converting constantly said specific temperature of said steady fuel into an electronic signal to be sent to said integrated circuit;
b) monitoring constantly said specific temperature of said steady fuel with the help of said integrated circuit to determine whether said specific temperature of said steady fuel is within a preset temperature range or not; and
c) repeating constantly/continually said detecting function and said monitoring function unless the engine of said automobile is turned off.

18. The semiconductor controllers on said circuit board according to claim 17, wherein rapidly activating and deactivating said heating elements and continually repeating said activating function and said deactivating function as long as the engine of the automobile is turned on as follows:
a) activating rapidly said heating elements by said controllers on said circuit board if said probe at said advantageous junction of said outlet end is detecting said temperature of said fuel below said preset temperature range;
b) deactivating rapidly said heating elements by said controllers on said circuit board if said probe at said advantageous junction of said outlet end is detecting said temperature of said fuel above said preset temperature range; and
c) repeating rapidly/continually said activating function and said deactivating function by said controllers on said circuit board unless said engine of said automobile is turned off.

19. The thermocouple probe at said advantageous junction of said outlet end and the semiconductor controllers on said circuit board according to claim 18, wherein said probe constantly/continually detecting and monitoring said temperature of said fuel and said controllers rapidly/continually activating and deactivating said heating elements to lessen, elevate, and maintain said temperature of said fuel as long as the engine of the automobile is turned on as follows:
a) actuating rapidly all sets of said heating elements by said controllers to elevate said temperature of said fuel as soon as the ignition switch of said automobile is started;
b) deactivating rapidly said all sets except one set of said heating elements by said controllers to lessen/maintain said temperature of said fuel within said preset temperature range if said probe is detecting said temperature of said fuel above said preset temperature range, and having been continually working by said one set of said heating elements to prevent said temperature of said fuel dropping below said preset temperature range unless said engine of said automobile is turned off;
c) activating rapidly the other sets of said heating elements by said controllers to elevate/maintain said temperature of said fuel again within said preset temperature range if said probe is detecting said temperature of said fuel below said preset temperature range; and
d) repeating rapidly/continually said deactivating function to lessen/maintain and repeating rapidly/continually said activating function to elevate/maintain said temperature of said fuel within said preset temperature range by said controllers unless said engine of said automobile is turned off.

20. The thermocouple probe at said advantageous junction of said outlet end and the semiconductor controllers and the integrated circuit on said circuit board according to claim 19, wherein constantly/continually detecting and monitoring said temperature of said fuel and rapidly/continually activating and deactivating said heating elements to lessen, elevate, and maintain said temperature of said fuel as long as said engine of said automobile is turned on as follows:
a) actuating rapidly said all sets of said heating elements by said controllers to elevate said temperature of said fuel as soon as said ignition switch of said automobile is started;
b) detecting constantly said temperature of said fuel and converting constantly said temperature of said fuel into said electronic signal to be sent to said integrated circuit;
c) monitoring constantly said temperature of said fuel with the help of said integrated circuit to determine whether said temperature of said fuel is within said preset temperature range or not;
d) deactivating rapidly said other sets of said heating elements by said controllers and said integrated circuit to lessen/maintain said temperature of said fuel within said preset temperature range if said probe is detecting said temperature of said fuel
e) above said preset temperature range, and having been continually working by said one set of said heating elements to prevent said temperature of said fuel dropping below said preset temperature range unless said engine of said automobile is turned off;
f) activating rapidly said other sets of said heating elements by said controllers and said integrated circuit to elevate/maintain said temperature of said fuel again within said preset temperature range if said probe is detecting said temperature of said fuel below said preset temperature range;
g) elevating continually said temperature of said fuel by means of activating rapidly and maintaining continually said other sets of said heating elements by said controllers and said integrated circuit on said circuit board unless said probe is detecting said temperature of said fuel above said preset temperature range; and
h) repeating constantly/continually said detecting function and said monitoring function by said probe and repeating rapidly/continually said activating function and said deactivating function and said elevating function by said controllers and said integrated circuit, for said device to lessen, elevate, and maintain said temperature of said fuel within the preset temperature range unless said engine of said automobile is turned off.
